(19) United States
(12) Patent Application Publication
(10) Pub. No.: US 2025/0379501 A1
(43) Pub. Date: Dec. 11, 2025

(54) OSCILLATION SUPPRESSING CIRCUIT

(71) Applicant: FUJI ELECTRIC CO., LTD., Kanagawa (JP)

(72) Inventors: Ryuji YAMADA, Hachioji-city (JP); Kazuyuki YODA, Kobe-city (JP)

(21) Appl. No.: 19/308,283

(22) Filed: Aug. 24, 2025

Related U.S. Application Data
(63) Continuation of application No. PCT/JP2024/032747, filed on Sep. 12, 2024.

(30) Foreign Application Priority Data
Sep. 12, 2023 (JP) 2023-147705

(51) Int. Cl. H02M 1/00; H02J 7/00; H02M 3/335

(52) U.S. Cl. CPC H02M 1/0038; H02J 7/0063; H02M 3/33507; H02J 2207/20

(57) ABSTRACT

Provided is an oscillation suppressing circuit connected to a DC bus to which a DC power is supplied, wherein the DC bus is connected to at least two capacitors, and the oscillation suppressing circuit absorbs energy of the DC bus and discharges it to the DC bus, to suppress an electrical oscillation of the DC bus. The oscillation suppressing circuit may discharge the energy to the DC bus with a voltage lower than a voltage in a case of absorbing the energy of the DC bus.

The contents of the following patent application(s) are incorporated herein by reference:
NO. 2023-147705 filed in JP on Sep. 12, 2023
NO. PCT/JP2024/032747 filed in WO on Sep. 12, 2024.

### BACKGROUND

### 1. TECHNICAL FIELD

The present invention relates to an oscillation suppressing circuit.

### 2. RELATED ART

Conventionally, a power system in which each of battery portions formed of secondary

batteries are connected in parallel to a power conversion circuit is known (see Patent Document 1). In addition, a snubber apparatus to be attached to a terminal of a semiconductor module is known (see Patent Document 2).

### RELATED ART DOCUMENTS

### Patent Documents

Patent Document 1: Japanese Patent Application Publication No. 2013-135482

Patent Document 2: Japanese Patent Application Publication No. 2020-124023

### BRIEF DESCRIPTION OF THE DRAWINGS

FIG. 1 shows an example of a power storage system 100 including an oscillation suppressing circuit 60 in an embodiment of the present invention.

FIG. 2 shows a periphery of a DC bus 30 in FIG. 1.

FIG. 3 shows an operation of an oscillation suppressing circuit 60 for absorbing energy of the DC bus 30.

FIG. 4 shows an operation of the oscillation suppressing circuit 60 for discharging energy to the DC bus 30.

FIG. 5 shows a current waveform flowing through the DC bus 30 in an embodiment.

FIG. 6 is a schematic view describing an arrangement of the oscillation suppressing circuit 60.

FIG. 7A shows a periphery of a DC bus 30 in a comparative example.

FIG. 7B shows a current waveform flowing through the DC bus 30 in a comparative example.

FIG. 8 shows another example of the oscillation suppressing circuit 60.

FIG. 9 shows another example of the oscillation suppressing circuit 60.

FIG. 10 shows another example of the oscillation suppressing circuit 60.

### DESCRIPTION OF EXEMPLARY EMBODIMENTS

Hereinafter, the present invention will be described through embodiments of the invention, but the following embodiments do not limit the invention according to claims. In addition, not all combinations of features described in the embodiments are essential to a solution of the invention.

In the present specification, phrases such as “connected” are not limited to being directly connected without another element but shall include being indirectly connected via another element. In addition, in the present specification, phrases such as “connected between . . . and . . . ” “provided between . . . and . . . ”, or “arranged between . . . and . . . ” shall mean “electrically connected to . . . and . . . ” rather than limiting physical arrangement.

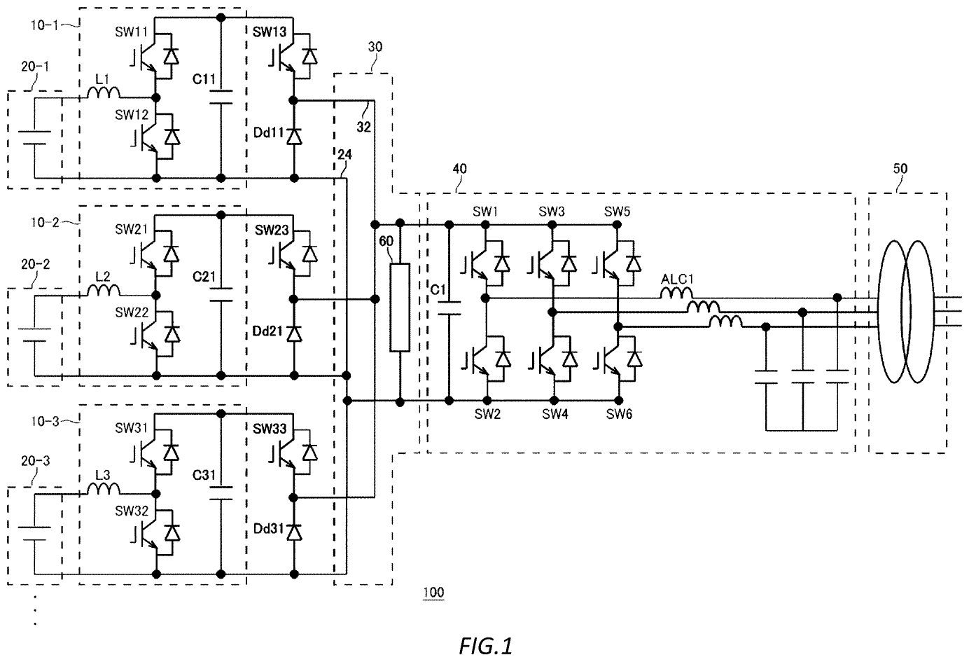

FIG. 1 shows an example of a power storage system 100 including an oscillation suppressing circuit 60 in an embodiment of the present invention. The power storage system 100 is connected to a power facility, stores power from the power facility and also supplies the power to the power facility. The power facility includes a power generation equipment using renewable energy, for example. The power storage system 100 stores excess power in the power generation equipment, and also supplies the power from the power storage system 100 when the power generation equipment lacks the power. The power facility may be an electrical grid. The power storage system 100 supplies power for the electrical grid, and also stores the power from the electrical grid.

The power storage system 100 includes one or more DC-DC converters 10, one or more batteries 20, a DC bus 30, a power conditioning system 40 and a transformer 50. The battery 20 may be a secondary battery. The battery 20 outputs a predetermined battery voltage. The DC-DC converters 10 are provided for each of the batteries 20. The DC-DC converters 10 are provided between the batteries 20 and the DC bus 30. The DC-DC converters 10 convert a battery voltage into a voltage of the DC bus 30 (for example, stepping up). The battery voltage is the voltage in an output terminal of the battery 20. The DC-DC converter 10 may convert the voltage of the DC bus 30 into the battery voltage (for example, stepping down) and then charge the battery.

The DC-DC converter 10-1 in the present example has a switch SW11, a switch SW12, inductor L1, and a capacitor C11. The DC-DC converter 10-1 in the present example performs a voltage conversion by operating as a stepping up chopper or a stepping down chopper. Note that the configuration of the DC-DC converter 10-1 is not limited to this. There is no problem as long as the DC-DC converter 10-1 can convert the voltage.

A plurality of DC-DC converters 10 are connected to the DC bus 30. In FIG. 1, there are three DC-DC converters 10 and three batteries 20, respectively, but the power storage system 100 may include the DC-DC converters 10 and the batteries 20 with a greater or less than three.

DC power is supplied to the DC bus 30. To the DC bus 30 of the present example, one or more batteries 20 are connected. Each of the DC-DC converters 10 may operate such that the voltage of the DC bus 30 maintains a predetermined value. The DC bus 30 of the present example includes a high potential line 32 and a reference potential line 24. The high potential line 32 has a voltage higher than that of the reference potential line 24. The reference potential line 24 is connected to a low potential side terminal of each of the batteries 20. The high potential line 32 is connected to an output terminal of each of the DC-DC converters 10. The voltage of the DC bus 30 is a voltage difference between the high potential line 32 and the reference potential line 24.

The power conditioning system 40 performs a conversion of DC power and AC power. One side of the power conditioning system 40 is connected to the DC bus 30, and the other side is connected to the transformer 50. The power conditioning system 40 converts DC power of the DC bus 30 into AC power and supplies the AC power to the transformer 50. In addition, the power conditioning system 40 converts AC power of the transformer 50 into DC power and supplies the DC power to the DC bus 30.

The power conditioning system 40 of the present example has a capacitor C1 that is charged by the voltage of the DC bus 30 or the voltage from the transformer 50. The power conditioning system 40 of the present example includes a three-phase inverter that converts DC power from the capacitor C1 into AC power and converts AC power from the transformer 50 into DC power. The three-phase inverter has a switch SW1 to SW6 and the switches SW1 and SW2, the switches SW3 and SW4, and the switches SW5 and SW6 correspond to each arm of the three-phase inverter. An inductor ALC1 is connected to a connection point of the switch of each arm. A capacitor may be provided between each inductor ALC1 and a reference potential. Note that the structure of the power conditioning system 40 is not limited to this. There is no problem as long as the power conditioning system 40 can convert the DC power and the AC power to and from each other.

The transformer 50 converts the voltage of the AC power. The transformer 50 converts the voltage of the AC power that is output from the power conditioning system 40 and outputs the converted voltage to the power facility. In addition, the transformer 50 converts the voltage of the AC power of the power facility and outputs the converted voltage to the power conditioning system 40.

The DC bus 30 is connected to at least two capacitors. In the case of the present example, the DC bus 30 is connected to a capacitor C11 included in the DC-DC converter 10 and a capacitor C1 included in the power conditioning system 40. Therefore, as an example, an LC circuit is formed in the vicinity of the DC bus 30 by an inductance of wiring of the capacitor C11, the capacitor C1, and the DC bus. Note that both of the at least two capacitors described above may be capacitors provided in the DC-DC converter 10, for example, the capacitor C11 included in the DC-DC converter 10-1 and the capacitor C 21 included in the DC-DC converter 10-2.

When a voltage (or current) is applied to the LC circuit from the outside, an oscillation of the voltage (or current) is generated in the circuit. Furthermore, if a switching frequency or its integer multiple at the time of a stepping up and down operation of the DC-DC converter 10 matches a resonance frequency of the LC circuit, a resonance occurs and a current value increases.

The power storage system 100 has an oscillation suppressing circuit 60 to be connected to the DC bus 30. The oscillation suppressing circuit 60 suppresses electrical oscillation generated in the LC circuit described above. The configuration of the oscillation suppressing circuit 60 is described below. The electrical oscillation may be oscillation of current, or may be oscillation of voltage.

The oscillation suppressing circuit 60 may be provided between the power conditioning system 40 and at least one DC-DC converter 10. The oscillation suppressing circuit 60 may be provided between at least one DC-DC converter 10 and the DC bus 30, may be provided inside the DC bus 30, or may be provided between the DC bus 30 and the power conditioning system 40.

A restriction switch SW13 may be provided between the DC-DC converter 10 and the DC bus 30. Furthermore, a freewheeling diode Dd11 may be provided between the restriction switch SW13 and the reference potential line 24. The restriction switch SW13 restricts the current flowing through the DC bus 30. The restriction switch SW13 may be provided separately from a switch that is provided in a chopper circuit of the DC-DC converter 10. The freewheeling diode Dd11 is responsible for ensuring a current path of a current flowing through an inductance of the DC bus 30 during an OFF period of the restriction switch SW13. The restriction switch SW13 and the freewheeling diode Dd11 may be provided for each DC-DC converter 10.

The oscillation suppressing circuit 60 may be provided between the restriction switch SW13 and the DC bus 30. The oscillation suppressing circuit 60 may be provided between the freewheeling diode Dd11 and the DC bus 30.

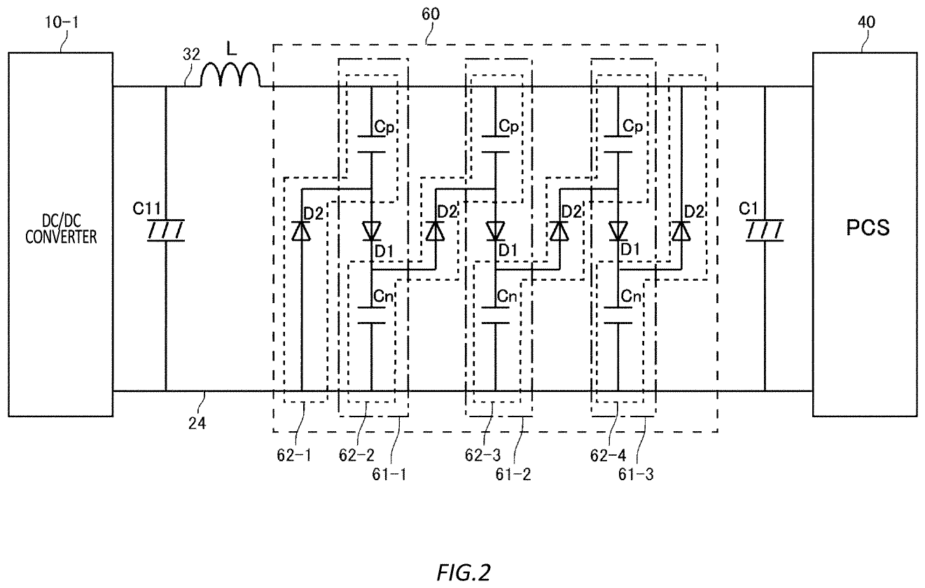

FIG. 2 shows a periphery of a DC bus 30 in FIG. 1. In FIG. 2, the DC-DC converter 10-1 and the power conditioning system 40 are illustrated by way of example. In addition, components other than the capacitor C11 of the DC-DC converter 10-1 are schematically represented. The capacitor C11 may be included in the DC-DC converter 10-1 or may be provided between the DC-DC converter 10-1 and the DC bus 30. The same is applied to the power conditioning system 40. In addition, the restriction switch SW13 and the freewheeling diode Dd11 in FIG. 1 are omitted. In addition, as described above, another DC-DC converter 10 (for example, the DC-DC converter 10-2) instead of the power conditioning system 40 may be connected. The inductor L represents an inductance of the wiring of the DC bus 30.

The oscillation suppressing circuit 60 is connected between the high potential line 32 of the DC bus 30 and the reference potential line 24. In addition to a case in which a voltage is applied by a switching operation of the DC-DC converter 10 described above, in a case in which the current (voltage) of the DC bus 30 is rapidly changed by a load of the power conditioning system 40 that is rapidly changed or a merging or a decoupling of the DC-DC converter 10, a pulse current (pulse voltage) is also generated by the inductance of the wiring of the DC bus 30 or the like, and oscillation of the current in the DC bus 30 begins. In the present specification, a current (voltage) that causes an electrical oscillation on the DC bus 30 may be described by being referred to as a pulse current (pulse voltage). The oscillation suppressing circuit 60 suppresses the electrical oscillation of the DC bus 30 by absorbing energy of the DC bus 30 and discharging it to the DC bus 30. Absorbing the energy of the DC bus 30 may be absorbing the energy of the pulse current (pulse voltage).

The oscillation suppressing circuit 60 includes a charge path 61 that has an absorption capacitor and a discharge suppressing diode connected to the DC bus 30, the charge path 61 absorbing the energy of the DC bus 30, and a discharge path 62 that is a path different from the discharge suppressing diode described above, the discharge path 62 performing discharging to the DC bus 30 at a voltage lower than that of the absorption capacitor described above. In the present embodiment, a positive side capacitor Cp and a negative side capacitor Cn described below correspond to the absorption capacitor, and a first diode D1 corresponds to the discharge suppressing diode.

The oscillation suppressing circuit 60 of the present example has n parallel charge paths 61 and n+1 parallel discharge paths 62. Note that the number n is an integer that is greater than or equal to 1, and is 3 in the present embodiment as an example. In addition, in the present embodiment, as an example, the three charge paths 61 are described as a first charge path 61-1, a second charge path 61-2, and a third charge path 61-3 sequentially from the left side of the diagram. In addition, four discharge paths 62 are described as a first discharge path 62-1, a second discharge path 62-2, a third discharge path 62-3, and a fourth discharge path 62-4 sequentially from the left side of the diagram.

Each charge path 61 has a positive side capacitor Cp, a first diode D1, and a negative side capacitor Cn that are sequentially connected in series between the high potential line 32 and the reference potential line 24. The positive side capacitor Cp and the negative side capacitor Cn may absorb electrical oscillation caused in the DC bus 30 by the pulse voltage. Each of the positive side capacitor Cp and the negative side capacitor Cn may be a film capacitor or a stacked ceramic capacitor as an example.

The first diode D1 is arranged with an anode facing a high potential line 32 side and a cathode facing a reference potential line 24 side. In this way, each charge path 61 causes a current to flow from the high potential line 32 side to the reference potential line 24 side.

Each discharge path 62 has a second diode D2. The second diode D2 is connected between the reference potential line 24 or the negative side capacitor Cn in an Nth charge path 61 (note that N is an integer where 0≤N≤n) among the n charge paths 61 and the positive side capacitor Cp in N+1th charge path 61 among the n charge paths 61 or the high potential line 32. For example, the second diode D2 of the first discharge path 62-1 is connected between the reference potential line 24 and the positive side capacitor Cp of the first charge path 61-1. The second diode D2 of the second discharge path 62-2 is connected between the negative side capacitor Cn of the first charge path 61-1 and the positive side capacitor Cp of the second charge path 61-2. The second diode D2 of the third discharge path 62-3 is connected between the negative side capacitor Cn of the second charge path 61-2 and the positive side capacitor Cp of the third charge path 61-3. The second diode D2 of the fourth discharge path 62-4 is connected between the negative side capacitor Cn of the third charge path 61-3 and the high potential line 32. The second diode D2 is arranged with an anode facing an Nth charge path 61-N side or a reference potential line 24 side and a cathode facing an N+1th charge path 61−(N+1) side or a high potential line 32 side. In this way, each discharge path 62 causes a current to flow from the reference potential line 24 side to the high potential line 32 side via at least one of the negative side capacitor Cn or the positive side capacitor Cp.

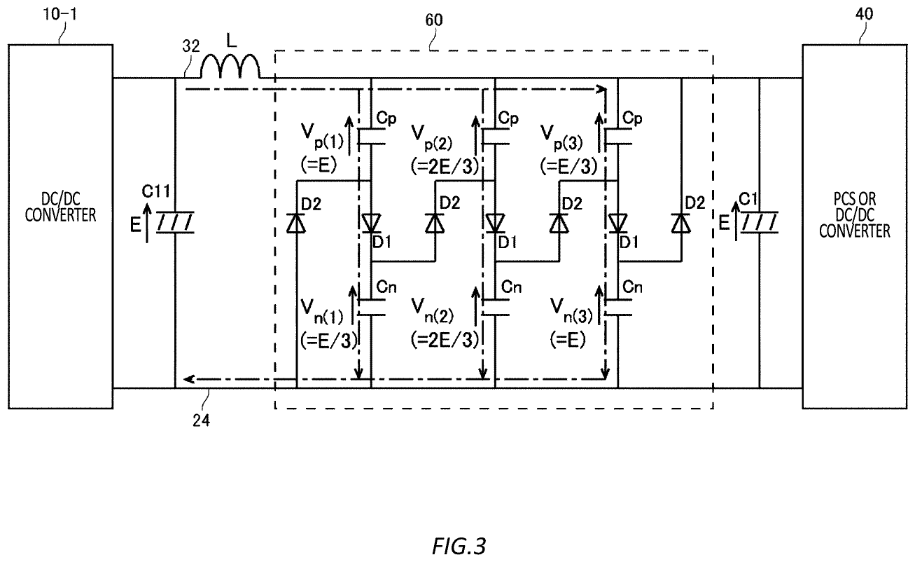

FIG. 3 shows an operation of an oscillation suppressing circuit 60 for absorbing energy of the DC bus 30. When the electrical oscillation is generated by the pulse current of the DC bus 30, a current flows from the high potential line 32 to the reference potential line 24 through the positive side capacitor Cp of each charge path 61, the first diode D1, and the negative side capacitor Cn. An arrow of a one-dot chain line in the figure represents a current path at the time of absorption. In this way, the energy of the DC bus 30 is absorbed by charging of the positive side capacitor Cp and the negative side capacitor Cn of the charge path 61.

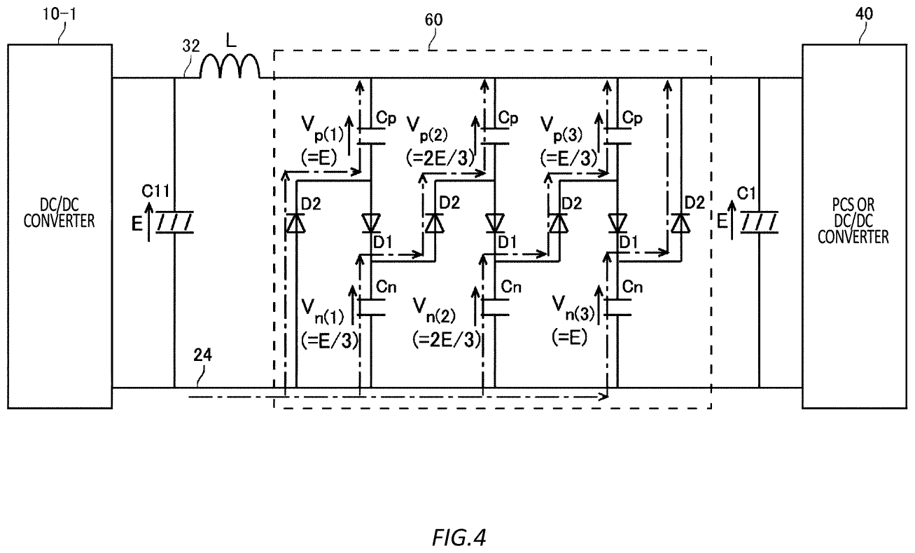

FIG. 4 shows an operation of the oscillation suppressing circuit 60 for discharging energy to the DC bus 30. The oscillation suppressing circuit 60 discharges the absorbed energy described above to the DC bus 30. The oscillation suppressing circuit 60 causes a current to flow through the reference potential line 24, the second diode D2 of each discharge path 62, and a path of the high potential line 32, and discharges the energy stored in the positive side capacitor Cp and/or the negative side capacitor Cn on the anode side/cathode side of the second diode D2 at this time. An arrow of a one-dot chain line in the figure represents a current path at the time of discharging.

Here, a voltage of the positive side capacitor Cp and the negative side capacitor Cn at the time of energy absorption and discharging operation of the oscillation suppressing circuit 60 is described. A relationship between the voltage of the positive side capacitor Cp and the voltage of the negative side capacitor Cn of each charge path 61 at the time of the energy absorption operation is represented in the following expression 1. However, in the expression, E is the voltage of the capacitor C11 and the capacitor C1, Vdc-off is the voltage between the high potential line 32 and the reference potential line 24 at the time of the generation of the electrical oscillation by the pulse voltage. In addition, Vp(1) to Vp(3) are the voltages of the positive side capacitor Cp in the first charge path 61-1 to the third charge path 61-3. In addition, Vn(1) to Vn(3) are the voltages of the negative side capacitor Cn in the first charge path 61-1 to the third charge path 61-3.

$$\begin{matrix}E \leq ( Vp ( 1 ) + Vn ( 1 ) ) \\ = ( Vp ( 2 ) + Vn ( 2 ) ) \\ = ( Vp ( 3 ) + Vn ( 3 ) ) \\ = Vdc - off\end{matrix} \qquad ( 1 )$$

In addition, a relationship between the voltage of the positive side capacitor Cp and the voltage of the negative side capacitor Cn of each charge path 61 at the time of an energy discharging operation is represented in the following expression 2. However, in the expression, Vdc-on is an inter-terminal voltage between the high potential line 32 and the reference potential line 24 at the time of the energy discharging operation.

$$\begin{matrix}E \geq Vp ( 1 ) \\ = ( Vn ( 1 ) + Vp ( 2 ) ) \\ = ( Vn ( 2 ) + Vp ( 3 ) ) \\ = Vn ( 3 ) \\ = Vdc - on\end{matrix} \qquad ( 2 )$$

By Expression 1 and Expression 2, the relationship between voltages of each positive side capacitor Cp and each negative side capacitor Cn is represented in the following Expression 3 (see the voltages illustrated in FIG. 3 and FIG. 4 as well). However, in the expression, Vdc is an inter-terminal voltage (the voltage of the DC bus 30) between the high potential line 32 and the reference potential line 24 at the time of steady state.

$$\begin{matrix}E = Vdc \approx Vp ( 1 ) \\ = Vn ( 3 ) \\ = 1.5 \times Vp ( 2 ) \\ = 1.5 \times Vn ( 2 ) \\ = 3 \times Vn ( 1 ) \\ = 3 \times Vp ( 3 )\end{matrix} \qquad ( 3 )$$

By Expression 3, it can be seen that a charging voltage in each charge path 61 when the oscillation suppressing circuit 60 absorbs the energy (4E/3 in FIG. 3, as an example) is higher than a discharging voltage in each of the discharge paths 62 when the energy is discharged (E in FIG. 3, as an example). That is, the oscillation suppressing circuit 60 discharges the energy to the DC bus 30 with a voltage lower than a voltage in a case of absorbing the energy of the DC bus 30. In addition, the voltage in the case of absorbing the energy of the DC bus 30 is higher than the voltage of the DC bus. Furthermore, a voltage in a case where the absorbed energy is discharged to the DC bus 30 is equal to the voltage of the DC bus 30. Note that even if the current flowing due to the pulse voltage flows into the oscillation suppressing circuit 60 from a power conditioning system 40 side, a similar effect is obtained by the symmetry of the circuit, thereby detailed description is omitted.

According to the oscillation suppressing circuit 60 in the DC bus 30 described above, n parallel charge paths 61 having the positive side capacitor Cp and the negative side capacitor Cn are provided. Accordingly, the electrical oscillation generated in the DC bus 30 by the pulse voltage passes through each charge path 61 to charge the positive side capacitor Cp and the negative side capacitor Cn with a voltage higher than the voltage between the high potential line 32 and the reference potential line 24. In this way, destructive failures of various types of apparatuses due to the electrical oscillation is prevented.

In addition, the oscillation suppressing circuit 60 is provided with n+1 discharge paths 62 which causes a current to flow from the reference potential line 24 side to the high potential line 32 side via at least one of the negative side capacitor Cn and the positive side capacitor Cp. Accordingly, if the oscillation suppressing circuit 60 discharges the absorbed energy to the DC bus 30, the energy accumulated in the positive side capacitor Cp or the negative side capacitor Cn is discharged, thereby reducing the discharging voltage of each discharge path 62 to be a voltage between the high potential line 32 and the reference potential line 24.

Herein, because the charging voltage in each of the n charge paths 61 in the case where the oscillation suppressing circuit 60 absorbs the energy is higher than the discharging voltage in each of the discharge paths 62 in the case where the energy is discharged, the energy charged via the charge path 61 cannot further charge the charge path 61 even though it is discharged by the discharge path 62. Accordingly, the energy that charged the positive side capacitor Cp and the negative side capacitor Cn is stored to be regenerated in the positive side capacitor Cp and the negative side capacitor Cn without being discharged by the oscillation operation of the inductor L and the positive side capacitor Cp or the negative side capacitor Cn and being consumed as a circuit loss. In this way, a circuit loss due to the oscillation operation is reduced and the energy can be effectively utilized. In addition, the allowable amount of the inductor L of the high potential line 32 and the reference potential line 24 can be increased. That is, a degree of freedom of a wiring length of each of the high potential line 32 and the reference potential line 24 can be increased. In the oscillation suppressing circuit 60 according to the present embodiment, a wiring

inductance of each of n (3 as an example in the present embodiment) charge paths 61 may be less than a wiring inductance of each of the discharge paths 62. In addition, the wiring length of each charge path 61 may be shorter than the wiring length of each discharge path 62. For example, a wiring length of each charge path 61 connecting the high potential line 32 and the reference potential line 24 may be shorter than a wiring length of each discharge path 62 connecting the high potential line 32 and the reference potential line 24. In addition, a wiring length of each wiring portion in three charge paths 61 may be shorter than a wiring length of each wiring portion in the n+1 discharge paths 62. In the present embodiment, as an example, each charge path 61 is disposed to have a linear shape between the high potential line 32 and the reference potential line 24, and the wiring portion of the charge path 61 has a linear shape. Note that the wiring portion may not be provided with an inductor as a circuit element.

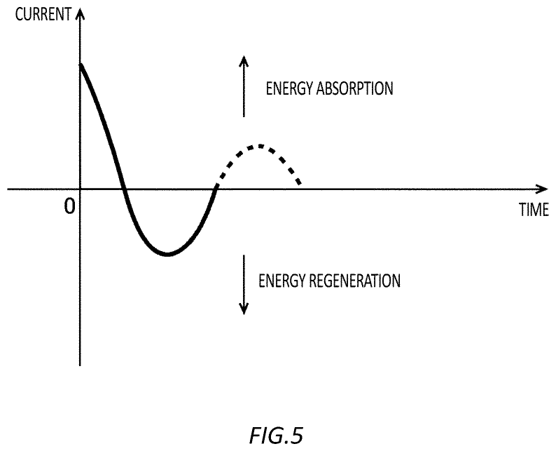

FIG. 5 shows a current waveform flowing through the DC bus 30 in an embodiment. In FIG. 5, the time point at which a pulse current is generated is-set to be 0, the horizontal axis represents time, and the vertical axis represents current. A positive current represents a current at a time when the oscillation suppressing circuit 60 performs charging, and a negative current represents a current at the time of discharging. That is, an integral value of a positive current waveform corresponds to an energy that is absorbed by the oscillation suppressing circuit 60 and an integral value of a negative current waveform corresponds to an energy that is regenerated (discharged) by the oscillation suppressing circuit 60.

As described above, because the charging voltage of the oscillation suppressing circuit 60 is higher than the discharging voltage, the energy discharged by the discharge path 62 does not be charged to the charge path 61 again. In addition, a voltage in a case where the absorbed energy is discharged to the DC bus 30 is approximately equal to the voltage of the DC bus 30. Therefore, the oscillation does not occur after the second cycle represented by the dotted line in the figure.

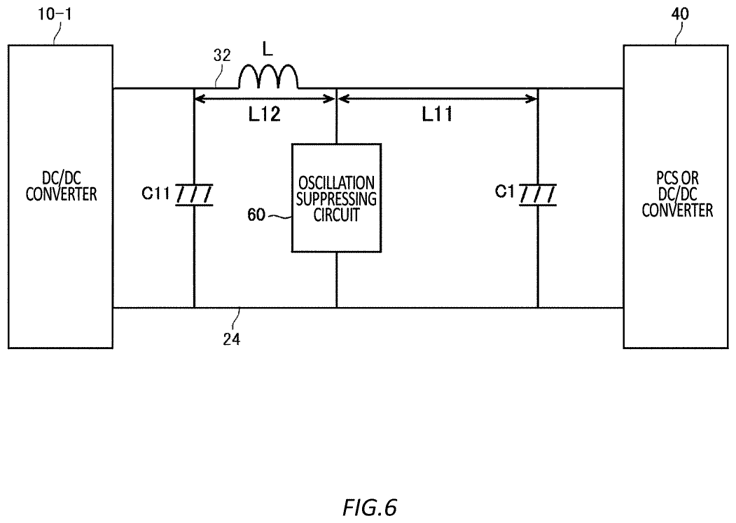

FIG. 6 is a schematic view describing an arrangement of the oscillation suppressing circuit 60. The oscillation suppressing circuit 60 may be provided between two capacitors. Thus, the oscillation that is generated between two capacitors can be suppressed. Two capacitors may be arranged between the high potential line 32 and the reference potential line 24. The two capacitors of the present example may include a first capacitor and a second capacitor that has less capacity than that of the first capacitor. In the example of FIG. 6, the capacitor C1 is the first capacitor and the capacitor C11 is the second capacitor. If an electric charge charged for the capacitor varies by a predetermined amount, a capacitor with less capacity will have an increased variation of the voltage of the capacitor. That is, the pulse voltage is easily generated. Therefore, a wiring length L12 between the oscillation suppressing circuit 60 and the second capacitor may be shorter than a wiring length L11 between the oscillation suppressing circuit 60 and the first capacitor.

A wiring length between the oscillation suppressing circuit 60 and the capacitor C1 of the power conditioning system 40 may be less than a wiring length between the oscillation suppressing circuit 60 and the capacitor of either of the plurality of DC-DC converters 10. A wiring length between the oscillation suppressing circuit 60 and the capacitor C1 of the power conditioning system 40 may be less than a wiring length between the oscillation suppressing circuit 60 and the capacitor of any of the plurality of DC-DC converters 10.

The oscillation suppressing circuit 60 may be provided with respect to each of the two capacitors. That is, the oscillation suppressing circuit 60 may be connected to a wiring in the vicinity of each capacitor. For example, a first oscillation suppressing circuit 60 may be arranged closer to the second capacitor than to the first capacitor, and a second oscillation suppressing circuit 60 may be arranged closer to the first capacitor than to the second capacitor. The oscillation suppressing circuit 60 may be provided to be the same number as the capacitors connected to the DC bus 30. In addition, the oscillation suppressing circuit 60 may be provided with respect to each of the plurality of DC-DC converters 10. For example, the oscillation suppressing circuit 60 may be provided inside each of the DC-DC converters 10, or may be provided between each of the DC-DC converters 10 and the DC bus 30. The oscillation suppressing circuit 60 may be provided to be the same number as the DC-DC converters 10 connected to the DC bus 30. By providing the plurality of oscillation suppressing circuits 60, the electrical oscillation can be further suppressed, and a greater amount of energy can be regenerated. At least one of the respective oscillation suppressing circuits 60 may be provided between any two of the capacitors, and all of the oscillation suppressing circuits 60 may be provided between any two of the capacitors.

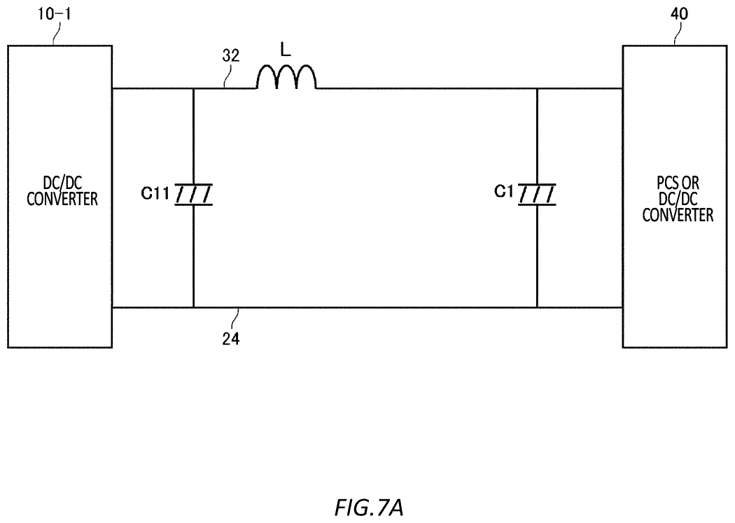

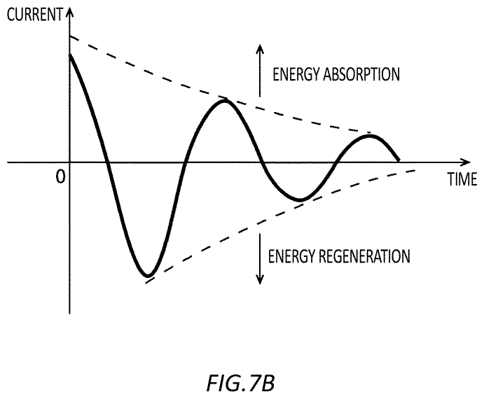

FIG. 7A shows a periphery of a DC bus 30 in a comparative example. FIG. 7B shows a current waveform flowing through the DC bus 30 in a comparative example. FIG. 7A corresponds to FIG. 2 in the embodiment, and FIG. 7B corresponds to FIG. 5 in the embodiment. Description of like reference numerals and the like are omitted. In the DC bus 30 of the present example, an oscillation suppressing circuit 60 is not provided. Therefore, after a pulse current is generated, an electrical oscillation is generated in the DC bus 30. The generated oscillation gradually decreases due to a loss by a resistance component of the DC bus 30. That is, a large amount of loss occurs because the energy is not regenerated.

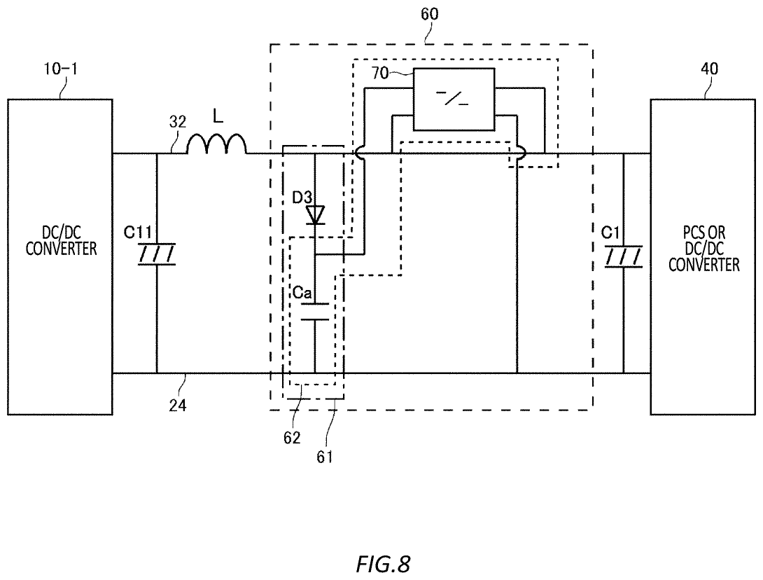

FIG. 8 shows another example of the oscillation suppressing circuit 60. The oscillation suppressing circuit 60 of the present example also includes the charge path 61 that causes a current to flow from the high potential line 32 to the reference potential line 24, and a discharge path 62 that causes a current to flow from the reference potential line 24 to the high potential line 32.

The charge path 61 of the present example has a discharge suppressing diode D3 and an absorption capacitor Ca sequentially connected in series between the high potential line 32 and the reference potential line 24 of the DC bus 30. The discharge suppressing diode D3 is arranged with an anode facing a high potential line 32 side and a cathode facing a reference potential line 24 side. The discharge path 62 of the present example has a DC-DC converter 70 connected to the absorption capacitor Ca and the DC bus 30. The absorption capacitor Ca of the present example functions as a component of both the charge path 61 and the discharge path 62.

If a pulse current is generated in the DC bus 30, the absorption capacitor Ca is charged through the charge path 61 by an electrical oscillation that is subsequently generated. Because the discharge suppressing diode D3 restricts the current of the charge path 61, the energy charged to the absorption capacitor Ca is not discharged through the charge path 61. Also in the present example, the energy absorbed by the oscillation suppressing circuit 60 from the DC bus 30 is discharged to the DC bus 30 through the discharge path 62.

As described above, a voltage value (amplitude) of the electrical oscillation generated by the pulse voltage is greater than the voltage of the capacitor C11 and the capacitor C1. That is, it is greater than the voltage of the DC bus 30. Therefore, the voltage of the absorption capacitor Ca that is charged by the electrical oscillation is greater than the voltage of the DC bus 30. The DC-DC converter 70 converts the voltage of the absorption capacitor Ca into the voltage of the DC bus 30. By adjusting the voltage in this way, the oscillation suppressing circuit 60 discharges the absorbed energy to the DC bus 30. The oscillation suppressing circuit 60 in the present example can also suppress the loss by suppressing the electrical oscillation of the DC bus 30, and regenerate the energy.

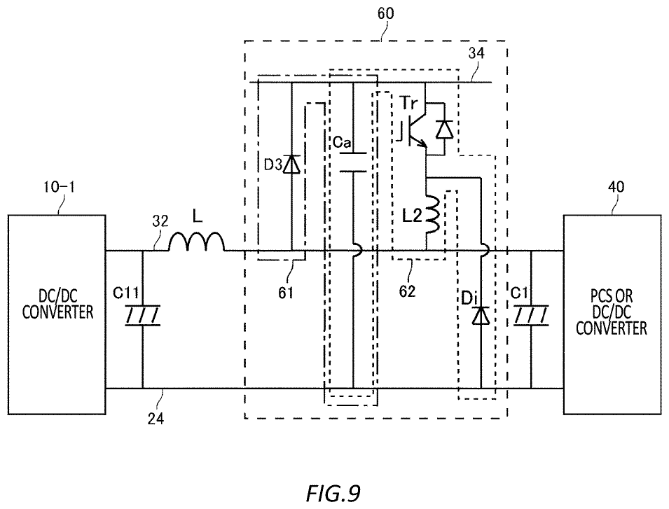

FIG. 9 shows another example of the oscillation suppressing circuit 60. The oscillation suppressing circuit 60 of the present example includes an absorption potential line 34, a charge path 61 and a discharge path 62. The absorption potential line 34 has a potential higher than that of the high potential line 32. The charge path 61 of the present example causes a current to flow from the high potential line 32 to the reference potential line 24 via the absorption potential line 34. The charge path 61 of the present example has a discharge suppressing diode D3 connected between the high potential line 32 and the absorption potential line 34, and an absorption capacitor Ca connected between the absorption potential line 34 and the reference potential line 24. An anode of the discharge suppressing diode D3 is connected to the high potential line 32, and a cathode is connected to the absorption potential line 34. A potential of the absorption potential line 34 has a value higher than a potential of the reference potential line 24 by an amount of the voltage of the absorption capacitor Ca.

The discharge path 62 of the present example has a transistor Tr, an inductor L2, a diode Di, and an absorption capacitor Ca. The transistor Tr connects between the absorption potential line 34 and the high potential line 32. The inductor L2 connects between the transistor Tr and the high potential line 32. The diode Di connects between a connection point between the transistor Tr and the inductor L2 and the reference potential line 24. An anode of the diode Di is connected to the reference potential line 24, and a cathode is connected to the transistor Tr and the inductor L2. The transistor Tr may be provided with a freewheeling diode.

If the transistor Tr is turned into an ON state while being in a state where the absorption capacitor Ca is charged by the electrical oscillation described above, the current flows from the reference potential line 24 to the high potential line 32 via the absorption potential line 34. In other words, the electric charge charged to the absorption capacitor Ca is discharged through the discharge path 62. Subsequently, once the transistor Tr is turned into an OFF state, an induced electromotive force is generated in the inductor L2, and the current flows from the reference potential line 24 to the high potential line 32 via the diode Di. Thus, the oscillation suppressing circuit 60 of the present example can also suppress the oscillation of the DC bus 30 and perform the energy regeneration.

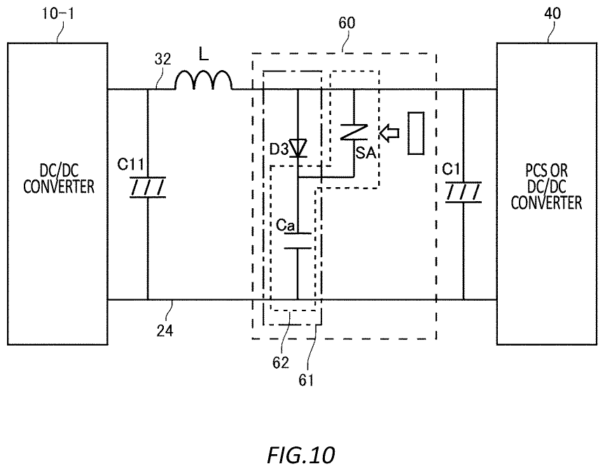

FIG. 10 shows another example of the oscillation suppressing circuit 60. The oscillation suppressing circuit 60 of the present example has the charge path 61 that causes a current to flow from the high potential line 32 to the reference potential line 24, and a discharge path 62 that causes a current to flow from the reference potential line 24 to the high potential line 32. The configuration of the charge path 61 is similar to that of FIG. 8. The oscillation suppressing circuit 60 of the present example has a constant voltage element SA connected to the absorption capacitor Ca and the DC bus 30. The constant voltage element SA may be a surge absorber.

The operation of the charge path 61 of the present example is the similar to that of FIG. 8. Note that in the present example, because the constant voltage element SA is provided to the discharge path 62, the voltage of the absorption capacitor Ca maintains a value higher than that of the voltage of the DC bus. Therefore, compared to the cases in FIGS. 2, 8, and 9, the electrical oscillation due to the pulse voltage can be quickly canceled so that the current attenuates early. Therefore, the present example can also suppress the loss.

While the present invention has been described by way of the embodiments, the technical scope of the present invention is not limited to the above-described embodiments. It is apparent to persons skilled in the art that various alterations or improvements can be made to the above-described embodiments. It is also apparent from the described scope of the claims that the embodiments to which such alterations or improvements are made can be included in the technical scope of the present invention.

What is claimed is:

1. An oscillation suppressing circuit connected to a DC bus to which a DC power is supplied, wherein
the DC bus is connected to at least two capacitors, and
the oscillation suppressing circuit absorbs energy of the DC bus and discharges it to the DC bus, to suppress an electrical oscillation of the DC bus.

2. The oscillation suppressing circuit according to claim 1, wherein the oscillation suppressing circuit discharges the energy to the DC bus with a voltage lower than a voltage in a case of absorbing the energy of the DC bus.

3. The oscillation suppressing circuit according to claim 2, wherein the voltage in the case of absorbing the energy of the DC bus is higher than a voltage of the DC bus.

4. The oscillation suppressing circuit according to claim 3, wherein a voltage in a case where the absorbed energy is discharged to the DC bus is equal to the voltage of the DC bus.

5. The oscillation suppressing circuit according to claim 1, wherein
The two capacitors includes a first capacitor and a second capacitor that has less capacity than that of the first capacitor, and
a wiring length between the oscillation suppressing circuit and the second capacitor is shorter than a wiring length between the oscillation suppressing circuit and the first capacitor.

6. The oscillation suppressing circuit according to claim 1, wherein the oscillation suppressing circuit is provided between the two capacitors.

7. The oscillation suppressing circuit according to claim 1, wherein the oscillation suppressing circuit is provided with respect to each of the two capacitors.

8. The oscillation suppressing circuit according to claim 1, wherein
a plurality of DC-DC converters having the capacitor, and
a power conditioning system having the capacitor
are connected to the DC bus, and
the oscillation suppressing circuit is provided between at least one of the plurality of DC-DC converters and the power conditioning system.

9. The oscillation suppressing circuit according to claim 8, wherein
a restriction switch is provided between the DC-DC converter and the DC bus, and
the oscillation suppressing circuit is provided between the restriction switch and the DC bus.

10. The oscillation suppressing circuit according to claim 8, wherein the oscillation suppressing circuit is provided with respect to each of the plurality of DC-DC converters.

11. The oscillation suppressing circuit according to claim 8, wherein a wiring length between the oscillation suppressing circuit and the capacitor of the power conditioning system is less than a wiring length between the oscillation suppressing circuit and the capacitor of either of the plurality of DC-DC converters.

12. The oscillation suppressing circuit according to claim 1, wherein the oscillation suppressing circuit comprises
a charge path that has an absorption capacitor and a discharge suppressing diode connect to the DC bus, the charge path absorbing the energy of the DC bus, and
a discharge path that is a path different from the discharge suppressing diode, the discharge path performing discharging to the DC bus at a voltage lower than that of the absorption capacitor.

13. The oscillation suppressing circuit according to claim 12, wherein the DC bus includes
a reference potential line, and
a high potential line having a potential higher than that of the reference potential line, and
the oscillation suppressing circuit includes
the charge path that is equal to n (note that n is an integer greater than or equal to 1) parallel charge paths, each of which has a positive side capacitor, a first diode, and a negative side capacitor sequentially connected in series between the high potential line of the DC bus and the reference potential line, and causes a current to flow from the high potential line to the reference potential line, and
the discharge path that is equal to n+1 parallel discharge paths, each of which has a second diode connected between the reference potential line or the negative side capacitor in an Nth charge path (note that N is an integer where 0≤N≤n) among the n charge paths and the positive side capacitor in N+1th charge path among the n charge paths or the high potential line, and causes a current to flow from the reference potential line to the high potential line via at least one of the negative side capacitor and the positive side capacitor.

14. The oscillation suppressing circuit according to claim 12, wherein
the DC bus includes
a reference potential line, and
a high potential line having a potential higher than that of the reference potential line, and
the oscillation suppressing circuit includes
the charge path that has the discharge suppressing diode and the absorption capacitor sequentially connected in series between the high potential line of the DC bus and the reference potential line, and causes a current to flow from the high potential line to the reference potential line, and
the discharge path that has a DC-DC converter connected to the absorption capacitor and the DC bus, and causes a current to flow from the reference potential line to the high potential line.

15. The oscillation suppressing circuit according to claim 12, wherein
the DC bus includes
a reference potential line, and
a high potential line having a potential higher than that of the reference potential line, and
the oscillation suppressing circuit includes
an absorption potential line having a potential higher than that of the high potential line,
the charge path that has the discharge suppressing diode connected between the high potential line of the DC bus and the absorption potential line and the absorption capacitor connected between the absorption potential line and the reference potential line, and causes a current to flow from the high potential line to the reference potential line via the absorption potential line, and
the discharge path that has a transistor and an inductor connected between the absorption potential line and the high potential line, and a diode connected between the reference potential line and a connection point of the transistor and the inductor, and causes a current to flow from the reference potential line to the high potential line.

16. The oscillation suppressing circuit according to claim 12, wherein
the DC bus includes
a reference potential line, and
a high potential line having a potential higher than that of the reference potential line, and
the oscillation suppressing circuit includes
the charge path that has the discharge suppressing diode and the absorption capacitor sequentially connected in series between the high potential line of the DC bus and the reference potential line and that causes a current to flow from the high potential line to the reference potential line, and
the discharge path that has a constant voltage element connected to the absorption capacitor and the DC bus and that causes a current to flow from the reference potential line to the high potential line.

17. The oscillation suppressing circuit according to claim 2, wherein
The two capacitors includes a first capacitor and a second capacitor that has less capacity than that of the first capacitor, and
a wiring length between the oscillation suppressing circuit and the second capacitor is shorter than a wiring length between the oscillation suppressing circuit and the first capacitor.

18. The oscillation suppressing circuit according to claim 3, wherein
The two capacitors includes a first capacitor and a second capacitor that has less capacity than that of the first capacitor, and
a wiring length between the oscillation suppressing circuit and the second capacitor is shorter than a wiring length between the oscillation suppressing circuit and the first capacitor.

19. The oscillation suppressing circuit according to claim 4, wherein
The two capacitors includes a first capacitor and a second capacitor that has less capacity than that of the first capacitor, and
a wiring length between the oscillation suppressing circuit and the second capacitor is shorter than a wiring length between the oscillation suppressing circuit and the first capacitor.

20. The oscillation suppressing circuit according to claim 2, wherein the oscillation suppressing circuit is provided between the two capacitors.
